(19) United States
(12) Patent Application Publication
(10) Pub. No.: US 2020/0376593 A1
(43) Pub. Date: Dec. 3, 2020

(54) MEASUREMENT DEVICE AND RECORDING MEDIUM ENCODING A PROGRAM

(71) Applicant: FANUC CORPORATION, Yamanashi (JP)

(72) Inventor: Junichi TEZUKA, Yamanashi (JP)

(21) Appl. No.: 16/884,374

(22) Filed: May 27, 2020

(30) Foreign Application Priority Data
May 27, 2019 (JP) 2019-098485

(51) Int. Cl. B23K 26/06; B23K 26/03

(52) U.S. Cl. CPC B23K 26/0643; B23K 26/032

(57) ABSTRACT

In a measurement device which measures an operation state of a galvanoscanner that scans a laser beam by reflecting the laser beam emitted from a laser light source by mirrors which are rotationally driven by motors, and operates based on an operation command, the measurement device includes: a position information acquisition unit which acquires a rotational position of the mirror in time series as position information; an irradiation position specification unit which specifies an irradiation position of the laser beam irradiated towards a workpiece, based on acquired position information; and an output unit which outputs the irradiation position of the laser beam specified to be visually confirmable.

This application is based on and claims the benefit of priority from Japanese Patent Application No. 2019-098485, filed on 27 May 2019, the content of which is incorporated herein by reference.

### BACKGROUND OF THE INVENTION

### Field of the Invention

The present invention relates to a measurement device and a recording medium encoded with a program.

### Related Art

A laser processing system has been known which performs processing such as welding by irradiating a laser beam towards a workpiece (object). As a laser processing system, for example, one has been known which includes a galvanoscanner that emits a laser beam at the leading end of an arm of an articulated robot.

The galvanoscanner includes at least two mirrors which are independently rotatable around two rotation axes. The galvanoscanner scans a laser beam emitted from a laser light source, by rotationally driving these mirrors by servomotors. The galvanoscanner causes the motors to operate based on command values designating the processing shape, for example.

The galvanoscanner may cause error to arise relative to the command value, depending on the response performance of the motor (inertia and friction). Error appears as overshoot of the position (path) of the laser beam, or the like. A drive pattern creation method of the galvanoscanner system for reducing such overshoot has been presented (for example, refer to Patent Document 1).

Patent Document 1: PCT International Publication No. 2009/139026

### SUMMARY OF THE INVENTION

However, in order to compensate for the error, it is preferable to be adjusted to match the processing conditions including the processing precision, processing contents and processing speed. With the method disclosed in Patent Document 1, the error between the predetermined position (command value) and the actual obtained coordinate position is calculated. However, it is not possible to confirm the actual obtained coordinate position. Therefore, in order to facilitate adjustment, it is preferable to be able to output the irradiation position of a laser beam in an easily visual confirmable manner.

A first aspect of the present disclosure is a measurement device (1) which measures an operation state of a galvanoscanner that scans a laser beam by reflecting the laser beam emitted from a laser light source by mirrors which are rotationally driven by motors, and operates based on an operation command, the measurement device including: a position information acquisition unit which acquires a rotational position of the mirror in time series as position information; an irradiation position specification unit which specifies an irradiation position of the laser beam irradiated towards a workpiece, based on acquired position information; and an output unit which outputs the irradiation position of the laser beam specified to be visually confirmable.

In addition, a second aspect of the present invention is a recording medium encoded with a program which causes a computer to function as a measurement device that measures an operation state of a galvanoscanner which scans a laser beam by reflecting the laser beam emitted from a laser light source by a mirror that is rotationally driven by a motor, and operates based on an operation command, the program causing the computer to function as: a position information acquisition unit (11) which acquires in a time series a rotational position of the mirror (21, 22) as position information; an irradiation position specification unit (16) which specifies an irradiation position (M2) of the laser beam (L) irradiated towards a workpiece, based on the position information acquired; and an output unit (18) which outputs the irradiation position (M2) of the laser beam (L) specified to be visually confirmable.

According to an aspect, it is possible to provide a measurement device and a recording medium encoded with a program which can output the irradiation position of a laser beam in an easily visually confirmable manner.

### BRIEF DESCRIPTION OF THE DRAWINGS

FIG. 1 is a schematic drawing showing the structure of a galvanoscanner measured by a measurement device according to a first embodiment;

FIG. 2 is a schematic drawing showing the relationship between the angle of a mirror of a galvanoscanner measured by the measurement device of the first embodiment and the irradiation position of a laser beam;

FIG. 3 is a schematic drawing showing the relationship between the measurement device of the first embodiment and the galvanoscanner;

FIG. 4 is a block diagram showing the configuration of the measurement device of the first embodiment;

FIG. 5 is a view of a screen showing a path of the laser beam outputted by the measurement device of the first embodiment and state information of a laser beam;

FIG. 6 is a schematic drawing showing an example of the irradiation position outputted by the measurement device of the first embodiment and the operation command; and

FIG. 7 is a schematic drawing showing another example of the irradiation position outputted by the measurement device of the first embodiment and the operation command.

### DETAILED DESCRIPTION OF THE INVENTION

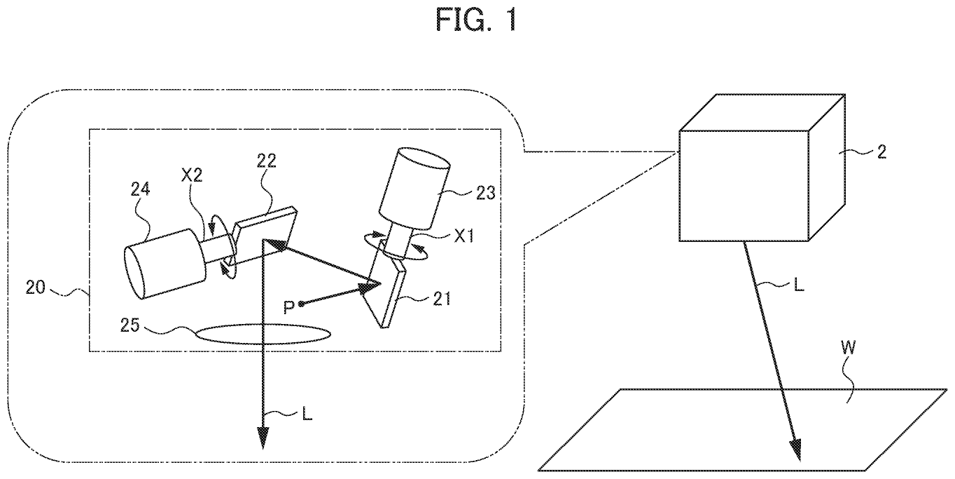

Hereinafter, a measurement device 1 and program according to an embodiment of the present disclosure will be explained by referencing FIGS. 1 to 7. First, before explaining the measurement device 1 and program according to the present embodiment, the configuration of a common galvanoscanner 2 will be explained.

The galvanoscanner 2, as shown in FIG. 1, has two mirrors 21, 22 which sequentially reflect a laser beam L from a laser light source P, and two motors 23, 24 which rotationally drive the mirrors 21, 22, respectively, around each of the rotation axes X1, X2, and a condensing lens 25 which condenses and emits the laser beam L. The mirrors 21, 22, motors 23, 24 and condensing lens 25 constitute an emission unit 20.

The mirrors 21, 22 are configured to be independently rotatable around the two rotation axes X1, X2. The motors 23, 24 are configured from servomotors, for example, and scan the laser beam L emitted from the laser light source P, by rotationally driving the mirrors 21, 22.

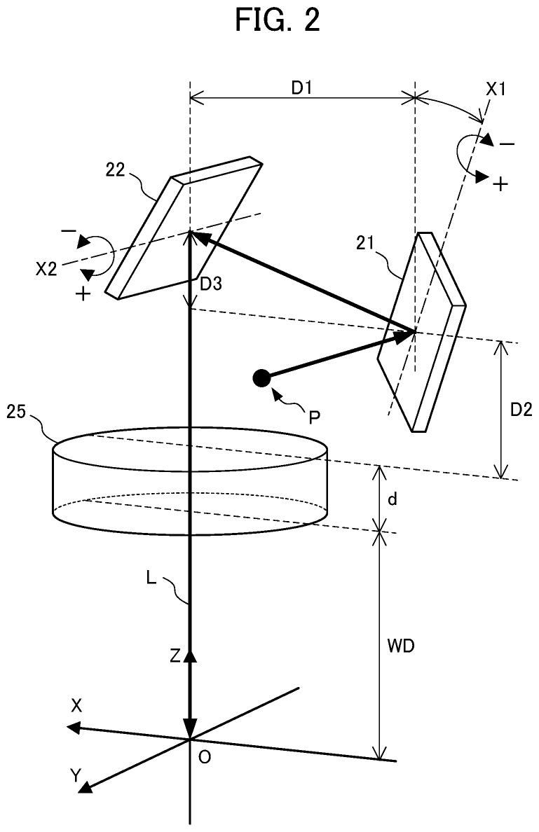

As shown in FIG. 1, the laser beam L from the laser light source P is sequentially reflected by the two mirrors 21, 22. The laser beam L is condensed by the condensing lens 25 and irradiated towards the workpiece W. At this time, when rotationally driving the two mirrors 21, 22 by the motors 23, 24, respectively, the incidence angle of the laser beam L incident on these mirrors 21, 22 continuously changes. As a result thereof, the laser beam L sequentially reflected by the mirrors 21, 22 to reach the workpiece W is scanned along a predetermined scanning path on the workpiece W. As shown in FIG. 2, in the reference position (rotational position) of the mirror 21 and mirror 22, if the laser beam L from the laser light source P is irradiated at the origin of the XY plane (workpiece W), the irradiation position (X coordinate and Y coordinate) of the laser beam L, for example, is expressed by the following formula.

X=D tan 2θ₂

Y=sqrt(D1²+D3²)tan 2θ₁+sqrt(D²+X²)tan 2θ₁

Provided that D=D3+D2+d+WD [Math. 1]

Herein, θ1 indicates the rotation angle from the reference position of the mirror 21. θ2 indicates the rotation angle from the reference position of the mirror 22. D1 indicates the interaxis distance in the X direction between the mirrors 21, 22. D2 indicates the distance in the height direction (Z direction) between the condensing lens 25 and the incident position of the laser beam from the laser light source P of the mirror 21. D3 indicates the distance in the height direction (Z direction) between the incident position of the laser beam on the mirror 21, and the incident position of the laser beam on the mirror 22. d+WD indicates the distance in the height direction (Z direction) from the top surface of the condensing lens 25 until the XY plane.

However, in the actual scan path of the laser beam L, the error occurs relative to the scan path set according to the operation command of the galvanoscanner 2. For example, in the actual operation path of the laser beam L, overshoot or the like occurs depending on the response performance (inertia and friction) of the mirrors 23, 24. The measurement device 1 and program according to the present embodiment enable outputting which scan path is actually followed to be visually confirmable relative to the set scan path.

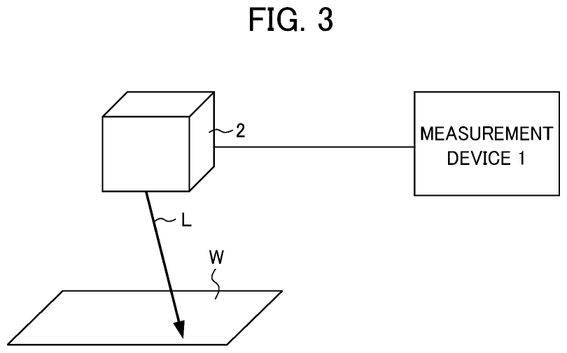

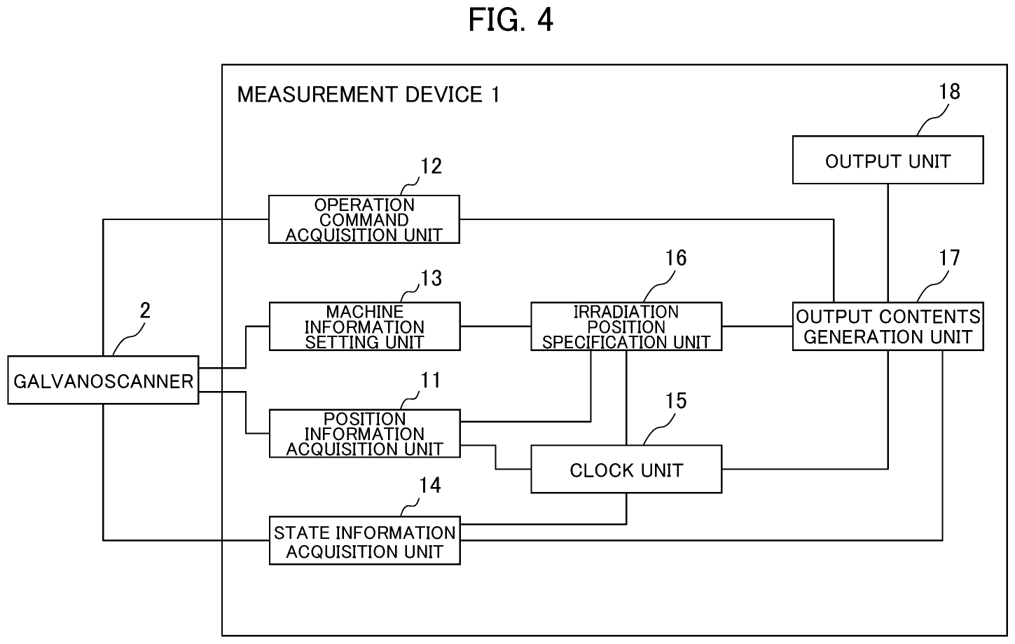

Next, the measurement device 1 and program according to the present embodiment will be explained by referencing FIGS. 3 to 7. The measurement device 1 is a device which measures the operation state of a galvanoscanner 2 which scans the laser beam L by causing the laser beam L emitted from the laser light source P to be reflected by the mirrors 21, 22 which are rotationally driven by the motors 23, 24, and operates based on an operation command. The measurement device 1 is connected to the galvanoscanner 2, as shown in FIG. 3. The measurement device 1, as shown in FIG. 4, includes: a position information acquisition unit 11, operation command acquisition unit 12, machine information setting unit 13, state information acquisition unit 14, irradiation position specification unit 16, clock unit 15, output contents generation unit 17, and output unit 18.

The position information acquisition unit 11, for example, is realized as a communication interface such as a modem. The position information acquisition unit 11 acquires the rotational positions of the mirrors 21, 22 in time series as position information. The position information acquisition unit 11 acquires the rotational position of the motors 23, 24 which synchronously rotate the mirrors 21, 22, for example. More specifically, the position information acquisition unit 11 acquires in time series as position information the output of encoders provided to the motors 23, 24. In other words, the position information acquisition unit 11 acquires in time series as position information the rotational positions of the motors 23, 24 which rotationally drive the two mirrors 21, 22, respectively. The position information acquisition unit 11, for example, acquires the rotational positions of the motors 23, 24 as the position information associated with the time measured by the clock unit 15 described later.

The operation command acquisition unit 12, for example, is realized as a communication interface such as a modem. The operation command acquisition unit 12 acquires an operation command set in advance, before operation of the galvanoscanner 2. The operation command acquisition unit 12 acquires the scan path depicting a circle as the operation command, for example.

The machine information setting unit 13 is realized by a CPU operating, for example. The machine information setting unit 13 sets the machine information indicating the irradiation position of the laser beam L relative to the mechanical positions of the mirrors 21, 22. The machine information setting unit 13, for example, sets machine information indicating the relationship between the rotational position of the mirror 21, 22 and the irradiation position of the laser beam L. In addition, the machine information setting unit 13, as the machine information, sets information related to the mechanism of the galvanoscanner 2, such as the distance from the plane (workpiece W) on which irradiating the laser beam until the mirrors 21, 22, and the angle of the mirror rotation axis.

The state information acquisition unit 14 is realized as a communication interface such as a modem, for example. The state information acquisition unit 14 acquires the time series change of the output state of the laser beam L as the state information. The state information acquisition unit 14, for example, acquires in time series as the state information the intensity (output level) of the laser beam L from the control unit (not shown) controlling operation of the galvanoscanner 2. The state information acquisition unit 14, for example, acquires the change in output state of the laser beam L as the state information associated with the time measured by the clock unit 15 described later.

The clock unit 15 is realized by the CPU operating, for example. The clock unit 15, for example, measures time.

The irradiation position specification unit 16, for example, is realized by the CPU operating. The irradiation position specification unit 16 specifies the irradiation position of the laser beam L irradiated towards the workpiece W, based on the acquired position information. The irradiation position specification 16, for example, specifies the irradiation position, by calculating the irradiation coordinates of the laser beam L on the surface of the workpiece W, based on the position information and machine information. In addition, the irradiation position specification unit 16 specifies the irradiation position of the laser beam L, associated with the time measured by the clock unit 15.

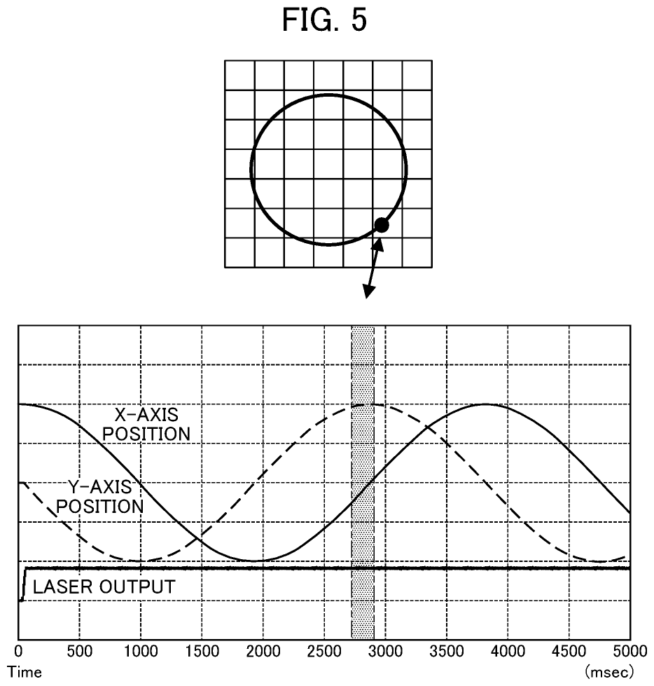

The output contents generation unit 17 is realized by the CPU operating, for example. The output contents generation unit 17 generates the irradiation position, operation command and state information as visually confirmable output contents to the user. The output contents generation unit 17 generates the output contents graphing the state information, as shown in FIG. 5, for example. In addition, the output contents generation unit 17 generates the output contents superimposing the irradiation position and operation command. Then, the output contents generation unit 17 generates visually confirmable output contents by associating the irradiation position and state information, based on the time obtained from the clock unit 15. The output contents generation unit 17, for example, generates output contents which can display the position on a graph showing the corresponding state information, by selecting the irradiation position, as shown in FIG. 5. In addition, the output contents generation unit 17 calculates the scanning speed of the laser beam L from the position information of the mirrors 21, 22 acquired in a time series by the position information acquisition unit 11, and generates the displayable output contents.

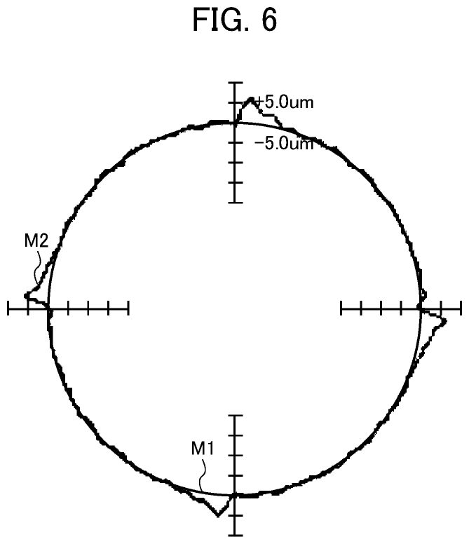

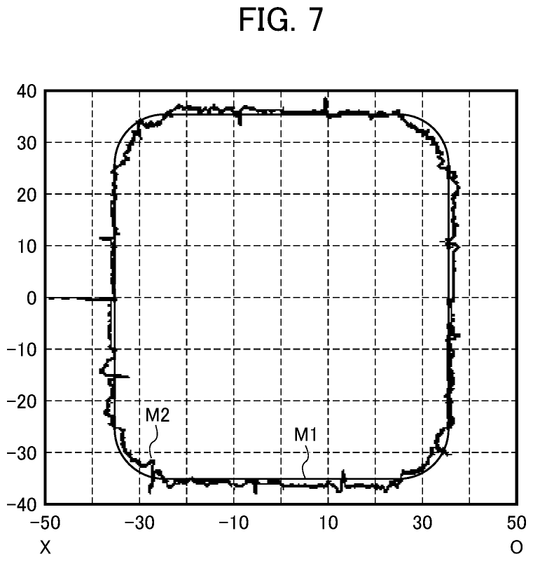

The output unit 18, for example, is a display device such as a display. The output unit 18 outputs the output contents generated by the output contents generation unit 17. More specifically, the output unit 18 outputs the specified irradiation position of the laser beam L to be visually confirmable. In addition, the output unit 18 outputs state information together with the irradiation position. In addition, the output unit 18 outputs by superimposing the irradiation position of the laser beam L set according to the operation command, and the irradiation position specified by the irradiation position specification unit 16 to be visually confirmable. The output unit 18, for example, outputs the specified irradiation position M2 to superimpose the operation command M1 depicting a circle, as shown in FIG. 6. In addition, the output unit 18, for example, outputs the specified irradiation position M2 to superimpose the operation command M1 depicting a chamfered rectangle, as shown in FIG. 7.

Next, flow of operation of the measurement device 1 and the program will be explained. First, the operation command acquisition unit 12 acquires the operation command M1 set in the galvanoscanner 2, and the operation command acquisition unit 12 sends the acquired operation command M1 to the output contents generation unit 17.

Next, the machine information setting unit 13 sets the machine information related to the galvanoscanner 2. The machine information setting unit 13 sends the set machine information to the irradiation position specification unit 16.

When the galvanoscanner 2 starts operation, the position information acquisition unit 11 acquires in time series the position information of the mirrors 21, 22 from the galvanoscanner 2. The position information acquisition unit 11 acquires in time series the position information of the motors 23, 24, for example. The position information acquisition unit 11 sends the acquired position information to the irradiation position specification unit 16.

In addition, the state information acquisition unit 14 acquires in time series the intensity of the laser beam L from the galvanoscanner 2 as state information. The state information acquisition unit 14 sends the acquired state information to the output contents generation unit 17.

The irradiation position specification unit 16 specifies the irradiation position M2 of the laser beam L relative to the workpiece W from the machine information and position information. The irradiation position specification unit 16 sends the specified irradiation position M2 to the output contents generation unit 17.

The output contents generation unit 17 generates output contents associating the sent operation command M1, irradiation position M2 and state information. The output contents generation unit 17 generates output contents superimposing the operation command M1 and irradiation position M2, for example. In addition, the output contents generation unit 17, for example, generates output contents which are visually confirmable, associating the time of the irradiation position M2 and time of state information, for example. The output contents generation unit 17 sends the generated output contents to the output unit 18.

The output unit 18 outputs the output contents in a visually confirmable state. The output unit 18, for example, outputs the output contents in a visually confirmable state by displaying the output contents.

Next, the program causing the computer to operate as the measurement device 1 will be explained. Each configuration included in the measurement device 1 can respectively be realized by hardware, software or a combination of these. Herein, realized by software indicates the matter of being realized by a computer reading out and executing a program.

The programs can be stored using a variety of types of non-transitory computer readable media, and supplied to the computer. The non-transitory computer readable media includes varies types of tangible storage media. Examples of non-transitory computer readable media include magnetic media (for example, flexible disks, magnetic tape, hard disk drive), magneto-optical recording media (for example, magneto-optical disk), CD-ROM (Read Only Memory), CD-R, CD-R/W, and semiconductor memory (for example, mask ROM, PROM (Programmable ROM), EPROM (Erasable PROM), flash ROM, RAM (random access memory)). In addition, the program may be supplied to the computer by various types of transitory computer readable media. Examples of transitory computer readable media include electrical signals, optical signals and electromagnetic waves. The transitory computer readable media can supply programs to a computer via a wired communication path such as electrical lines and optical fibers, or a wireless communication path.

According to the above measurement device 1 of the present embodiment, the following effects are exerted.

(1) In the measurement device 1 which measures the operation state of the galvanoscanner 2 that scans a laser beam L by reflecting the laser beam L emitted from the laser light source P by mirrors 21, 22 that are rotationally driven by the motors 23, 24 to scan the laser beam L, and operates based on the operation command M1, the measurement device 1 includes: the position information acquisition unit 11 that acquires the rotational position of the mirrors 21, 22 in time series as position information; the irradiation position specification unit 16 that specifies the irradiation position M2 of the laser beam L irradiated towards the workpiece W, based on the acquired position information; and the output unit 18 that outputs the specified irradiation position M2 of the laser beam L to be visually confirmable. It is thereby possible to easily visually recognize the actual irradiation position M2 of the laser beam L. Therefore, since it is possible to adjust the galvanoscanner 2 while confirming the irradiation position M2, adjustment of the galvanoscanner 2 can be done easily.
(2) The measurement device 1 further includes a machine information setting unit 13 which sets the machine information indicating the relationship between the mechanical positions of the mirrors 21, 22 and the irradiation position M2 of the laser beam L, and the irradiation position specification unit 16 specifies the irradiation position M2 of the laser beam L from the machine information and the position information. It is thereby possible to use the measurement device 1 even if a machine configuration differing for every galvanoscanner 2. Therefore, it is possible to raise the versatility of the measurement device 1.
(3) The measurement device 1 further includes a state information acquisition unit 14 that acquires the time series change in the output state of the laser beam L as state information, and the output unit 18 outputs the state information together with the irradiation position M2. It is thereby possible to easily visually confirm the operation state, in addition to the irradiation position M2 of the galvanoscanner 2. Therefore, it is possible to adjust while confirming in further detail the state of the galvanoscanner 2.
(4) The measurement device 1 further includes the operation command acquisition unit 12 which acquires the operation command M1, and the output unit 18 outputs by superimposing the irradiation position M2 of the laser beam L set according to the operation command M1, and the irradiation position M2 specified by the irradiation position specification unit 16 to be visually confirmable. It is thereby possible to easily visually confirm the error between the scan path of the operation command M1 and the actual scan path. Therefore, it is possible to easily confirm whether the error is in the permitted range.

Although a preferred embodiment of the measurement device and program of the present disclosure has been explained above, the present disclosure is not to be limited to the aforementioned embodiment, and modifications are possible where appropriate. For example, in the above-mentioned embodiment, the measurement device 1 is explained as being separate from the galvanoscanner 2; however, it is not limited thereto. The measurement device 1 may be integrated with the galvanoscanner 2. The measurement device 1, for example, may be built into the galvanoscanner 2.

In addition, in the above-mentioned embodiment, the position information acquisition unit 11 acquires the position information of the mirrors 21, 22, by acquiring the rotational position of the motors 23, 24; however, it is not limited thereto. The position information acquisition unit 11 may acquire the rotational positions of the mirrors 21, 22 directly as the position information.

In addition, in the above-mentioned embodiment, in the case of the measuring galvanoscanner 2 being fixed, the measurement device 1 may be storing machine information in advance. In this case, the measurement device 1 may not necessarily include the machine information setting unit 13.

In addition, in the above-mentioned embodiment, the output contents generation unit 17 generates the irradiated position M2, operation command M1 and state information as output contents; however, it is not limited thereto. The output contents generation unit 17 may be configured to generate output contents including at least the irradiation position M2.

In addition, in the above-mentioned embodiment, in a case such that the galvanoscanner 2 is mounted to the leading end of an arm of an industrial machine (robot, etc., not shown), the machine information setting unit 13 and position information acquisition unit 11 may be configured so as to acquire the machine information and position information related to at least three motors.

In addition, in the above-mentioned embodiment, the output unit 18 is configured to display output contents; however, it is not limited thereto. The output unit 18 may be configured to output the output contents by printing.

### EXPLANATION OF REFERENCE NUMERALS

1 measurement device
2 galvanoscanner
11 position information acquisition unit
12 operation command acquisition unit
13 machine information setting unit
14 state information acquisition unit
16 irradiation position specification unit
18 output unit
21, 22 mirror
23, 24 motor
L laser beam
P laser light source
M1 operation command
M2 irradiation position

What is claimed is:

1. A measurement device which measures an operation state of a galvanoscanner that scans a laser beam by reflecting the laser beam emitted from a laser light source by a mirror, which is rotationally driven by a motor, and operates based on an operation command, the measurement device comprising:
a position information acquisition unit which acquires a rotational position of the mirror in time series as position information;
an irradiation position specification unit which specifies an irradiation position of the laser beam irradiated towards a workpiece, based on acquired position information; and
an output unit which outputs the irradiation position of the laser beam specified to be visually confirmable.

2. The measurement device according to claim 1, further comprising a machine information setting unit which sets machine information indicating a relationship between a mechanical position of the mirror and the irradiation position of the laser beam,
wherein the irradiation position specification unit specifies the irradiation position of the laser beam from the machine information and the position information.

3. The measurement device according to claim 1, further comprising a state information acquisition unit which acquires a time series change of an output state of the laser beam as state information,
wherein the output unit outputs the state information together with the irradiation position.

4. The measurement device according to claim 1, further comprising an operation command acquisition unit which acquires the operation command,
wherein the output unit outputs by superimposing the irradiation position of the laser beam set by the operation command and the irradiation position specified by the irradiation position specification to be visually confirmable.

5. A recording medium encoded with a program which causes a computer to function as a measurement device that measures an operation state of a galvanoscanner which scans a laser beam by reflecting the laser beam emitted from a laser light source by a mirror that is rotationally driven by a motor, and operates based on an operation command, the program causing the computer to function as:
a position information acquisition unit which acquires in a time series a rotational position of the mirror as position information;
an irradiation position specification unit which specifies an irradiation position of the laser beam irradiated towards a workpiece, based on the position information acquired; and
an output unit which outputs the irradiation position of the laser beam specified to be visually confirmable.
